(19) United States
(12) Patent Application Publication
(10) Pub. No.: US 2026/0360682 A1
(43) Pub. Date: Nov. 12, 2026

(54) MASS SPECTROSCOPE

(71) Applicant: Hitachi High-Tech Corporation, Minato-ku, Tokyo (JP)

(72) Inventors: Shigeki YAMAGUCHI, Tokyo (JP); Yuichiro HASHIMOTO, Tokyo (JP); Naoto TSUJIMURA, Tokyo (JP)

(21) Appl. No.: 19/131,335

(22) PCT Filed: Nov. 16, 2023
(86) PCT No.: PCT/JP2023/041334

§ 371 Date: May 20, 2025

(30) Foreign Application Priority Data
Nov. 24, 2022 (JP) 2022-187237

(51) Int. Cl. H01J 49/04

(52) U.S. Cl. CPC H01J 49/0468; H01J 49/0409

(57) ABSTRACT

A mass spectroscope includes: a reagent refrigerator 21 for storing a reagent vessel; a mass spectrometry portion 40 for performing mass spectrometry on a sample which has been pretreated by reaction with a reagent contained in the reagent vessel; and gas piping 71 that is connected to a gas source 50 to supply an inert gas from the gas source. The gas piping is bifurcated into a first inert gas passage for supplying the inert gas to the mass spectrometry portion and a second inert gas passage for supplying the inert gas to the reagent refrigerator. Accordingly, it is possible to maintain the interior of the reagent refrigerator clean using the inert gas.

### TECHNICAL FIELD

This invention relates to a mass spectroscope.

### BACKGROUND ART

Patent Literature 1 discloses an automatic analyzer in which the interior of a reagent refrigerator for storing reagent vessels is maintained to be clean. If outside air flows into the reagent refrigerator for storing, at a low temperature for long periods of time, reagent vessels containing reagents used for analysis, then this may cause the mixing of dust, germs and/or the like included in the outside air, and/or condensation due to a temperature difference between the interior and the exterior of the reagent refrigerator, which in turn may lead to a risk of contamination of the interior of the reagent refrigerator. Therefore, while a reagent vessel replacement portion for replacement of reagent vessels is open, contamination in the reagent refrigerator is inhibited by producing a positive pressure in the interior of the reagent refrigerator with respect to surroundings of the reagent refrigerator or by removing dust or germs which adhere to the reagent vessel.

### CITATION LIST

### Patent Literature

Patent Literature 1: WO 2020/208914

### SUMMARY OF INVENTION

### Technical Problem

In Patent Literature 1, the inflow of room-temperature air is inhibited by producing a positive pressure within the reagent refrigerator during the replacement of the reagent vessel, so that condensation is inhibited from occurring in the interior of the reagent refrigerator. However, during the replacement of the reagent vessel, the reagent refrigerator is widely opened, and the air in the interior of the reagent refrigerator is mixed in association with the mechanism operation for reagent replacement. As a result, the inflow of outside air to some extent is inevitable.

A mass spectroscope is a device for ionizing a liquid sample to introduce the ionized liquid sample into a vacuum device, thereby to perform ion separation in accordance with the mass-to-charge ratio (m/z). For example, where the mass spectroscope generates ions using Electrospray Ionization (ESI techniques), inert gas (e.g., nitrogen gas) which is heated is injected to sample droplets. For this purpose, the mass spectroscope is configured to allow for introduction of inert gas from a gas source.

Given these circumstances, the inventors have conducted the study of utilization of the inert gas from the gas source in order to maintain the interior of a reagent refrigerator to be clean. It is an object of the present invention to provide a mass spectroscope capable of maintaining the interior of a reagent refrigerator to be clean by using inert gas.

### Solution to Problem

A mass spectroscope of one aspect of the present invention includes: a reagent refrigerator for storing a reagent vessel; a mass spectrometry portion for performing mass spectrometry on a sample which has been pretreated by reaction with a reagent contained in the reagent vessel; and gas piping that is connected to a gas source to supply an inert gas from the gas source. In the mass spectroscope, the gas piping is bifurcated into a first inert gas passage for supplying the inert gas to the mass spectrometry portion and a second inert gas passage for supplying the inert gas to the reagent refrigerator.

### Advantageous Effects of Invention

A mass spectroscope is provided in which an interior of a reagent refrigerator can be made clean by using an inert gas. Objects, and novel features other than the above will be apparent from the description and accompanying drawings of the present description.

### BRIEF DESCRIPTION OF DRAWINGS

FIG. 1 illustrates an example configuration of a mass spectroscope.

FIG. 2 is a block diagram illustrating an inert gas passage of the mass spectroscope.

FIG. 3 is a block diagram illustrating an inert gas passage and a cooling water passage in a reagent refrigerator.

### DESCRIPTION OF EMBODIMENTS

Hereinafter, one embodiment of the present invention will be described with reference to the accompanying drawings.

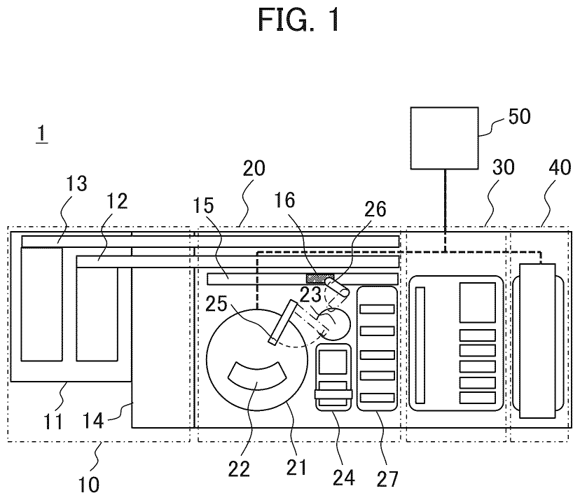

FIG. 1 illustrates an example configuration of a mass spectroscope 1 of the present embodiment. The mass spectroscope 1 includes, as a major configuration thereof, a sample loader 10, a pretreatment portion 20, a separator 30 and a mass spectrometry portion 40. A sample to be analyzed is contained in a sample vessel. The sample vessel is placed in a sample rack 16, and then is loaded in the mass spectroscope 1 from the sample loader 10.

The sample loader 10 includes a sample delivery portion 11 and a buffer 14. The sample rack 16 loaded into the sample delivery portion 11 is delivered toward the pretreatment portion 20 by a rack transfer mechanism 12. In the pretreatment portion 20, the sample rack 16 is transferred to a rack transfer mechanism 15. In a dispensing position on the rack transfer mechanism 15, the required amount of sample is dispensed from the sample vessel into a reaction vessel on an incubator 23. Upon the completion of dispensing of all the samples contained in a plurality of sample vessels placed in the sample rack 16, the sample rack 16 is transferred from the rack transfer mechanism 15 to a rack transfer mechanism 13. Then, the sample rack 16 is returned to the sample delivery portion 11 by the rack transfer mechanism 13, which is then collected by an operator. In a case where the number of the sample racks 16 loaded in the sample delivery portion 11 is too large to catch up the analysis treatment in the device 1, the buffer 14 is used for temporary evacuation of the sample racks 16 for safety so as to prevent the sample racks 16 from being accumulated on the rack transfer mechanism 12. It is noted that, in the example in FIG. 1, a conveyor belt type transfer mechanism is illustrated as the rack transfer mechanism, but the rack transfer mechanism is not limited to this type.

The pretreatment portion 20 is a unit to perform pretreatment for mass spectrometry. The details of pretreatment are not limited. For example, in the pretreatment portion 20, treatment is performed to amplify a component to be analyzed in the sample. The pretreatment portion 20 includes a reagent refrigerator 21 for storing reagents required for pretreatment, the incubator 23, a reaction vessel feed mechanism 24, a reagent dispensing mechanism 25, a sample dispensing mechanism 26 and a sample extraction portion 27. The incubator 23 maintains a liquid mixture of a reagent with a sample at a constant temperature to accelerate a reaction. The reaction vessel feed mechanism 24 stores a reaction vessel in which the reagent and the sample are mixed with each other and supply the reaction vessel to the incubator 23. The reagent dispensing mechanism 25 dispenses a reagent from a reagent vessel stored in the reagent refrigerator 21 into the reaction vessel on the incubator 23. The sample dispensing mechanism 26 dispenses a sample from a sample vessel on the sample rack 16 into the reaction vessel on the incubator 23. The sample extraction portion 27 removes an unnecessary component in subsequent analysis from a reaction liquid between the reagent and the sample after the reaction on the incubator 23.

The separator 30 is a unit to separate the sample pretreated in the pretreatment portion 20 into a plurality of components. The mass spectrometry portion 40 is a unit to perform mass spectrometry on the plurality of components thus separated by the separator 30 (mass spectrometer). As the separator 30, liquid chromatograph is used. An analysis technique using a mass spectrometer as a liquid chromatography detector is known as liquid chromatography mass spectrometry (LC-MS).

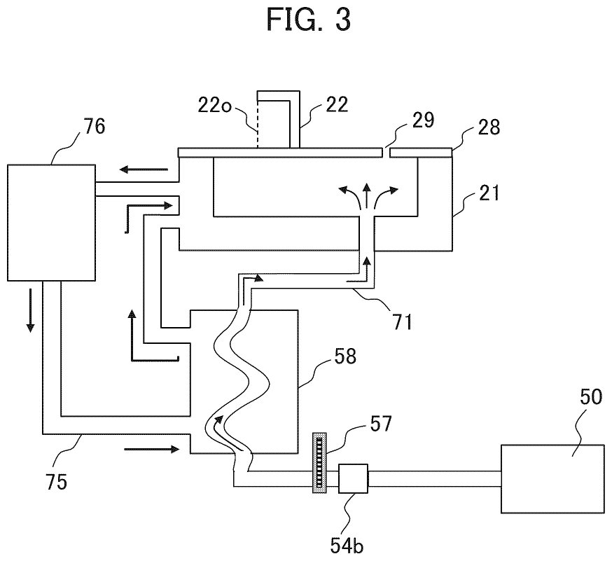

The structure of the reagent refrigerator 21 is briefly described with reference to FIG. 1 and FIG. 3. FIG. 3 illustrates the reagent refrigerator 21 as a section diagram. The reagent refrigerator 21 is supplied with cooling water in order to maintain its interior at low temperatures. Also, a lid 28 is secured to the reagent refrigerator 21. The lid 28 is provided with a reagent replacement mechanism 22 and a dispensing hole 29. Also, a reagent disk for holding the reagent is rotatably mounted in the reagent refrigerator 21, which is not shown. The reagent replacement mechanism 22 is interrupted with respect to the reagent refrigerator 21 under normal conditions so that outside air is prevented from flowing into the reagent refrigerator 21. However, because, during reagent replacement, a reagent is loaded on/unloaded from the reagent disk within the refrigerator through an opening 22o, on this occasion the outside air flows into the reagent refrigerator 21. Also, because the reagent dispensing mechanism 25 dispenses the reagent from a reagent vessel, the dispensing hole 29 through which a probe passes is open at all times although its opening area is small.

In this way, it is difficult to interrupt the outside air from the interior of the reagent refrigerator 21 at all times. Therefore, if condensation occurs in the interior of the reagent refrigerator 21, there is a risk of growth of mold and/or germs. In the embodiment, attention is focused on the supply of an inert gas from a gas source 50 to the mass spectroscope 1, and the inert gas from the gas source 50 without oxygen unlike the outside air is configured to be supplied to the reagent refrigerator 21 as well as the mass spectrometry portion 40, whereby the interior of the reagent refrigerator is kept clean.

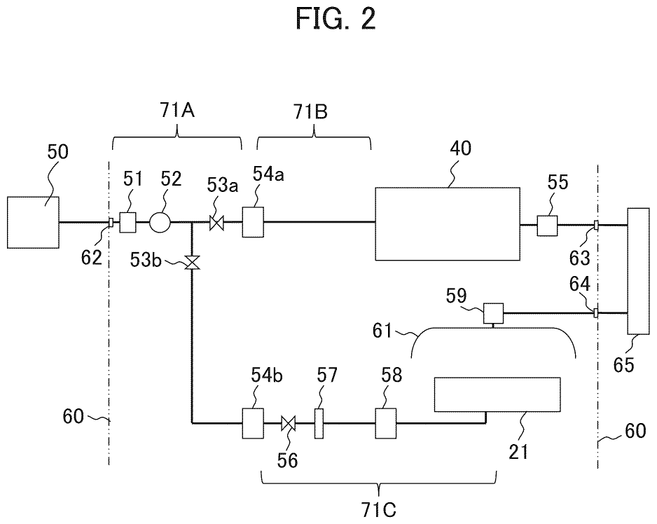

FIG. 2 is a block diagram illustrating an inert gas passage of the mass spectroscope. It is noted that a demarcation line 60 shown in a dash-dot-dot line illustrates conceptually a boundary between the mass spectroscope 1 and an external device. The gas source 50 may be a gas generator for generating inert gas or may be a tank in which inert gas is accumulated. A case of using a nitrogen gas as the inert gas is herein described. The gas source 50 is connected to gas piping 71 via a connection portion 62. The gas piping 71 divided into three sections A to C is herein described. It is noted that the passage configuration shown in FIG. 2 is provided by way of example only and not limited to this.

The section A is a section connected to the gas source 50 via the connection portion 62 and bifurcated into two at some midpoint, the bifurcated gas piping being extended to regulators 54a, 54b, respectively. The gas piping 71 in the section A is represented as gas piping 71A. A filter 51 and a pressure sensor 52 are arranged in the gas piping 71A from upstream to downstream. The filter 51 is mounted to protect the mechanism to be supplied with the inert gas, by trapping dust and/or microparticles if they are present in gas to be supplied to the gas piping 71. The pressure sensor 52 is mounted to monitor a pressure of the inert gas supplied from the gas source 50. In a downstream area of the pressure sensor 52, the gas piping 71A is bifurcated, in which one of the passages is connected to the regulator 54a for the mass spectrometry portion and the other is connected to the regulator 54b for the reagent refrigerator. Manual valves 53a and 53b are mounted respectively on the passages of the bifurcation. They are used if the supply of inert gas to the mass spectrometry portion 40 or the reagent refrigerator 21 is required to be shut off during device maintenance.

The section B is a section ranging from the regulator 54a to the mass spectrometry portion 40. The gas piping 71 in the section B is represented as gas piping 71B. The regulator 54a is mounted so as to reduce the gas pressure of the inert gas as compared with that in the section A and to supply the inert gas at a steady gas pressure to the mass spectrometry portion 40. After the inert gas supplied to the mass spectrometry portion 40 is used, for example, to ionize the sample, the inert gas is exhausted by a vacuum pump 55 and then treated by exhaust equipment 65 connected via a connection portion 63.

The section C is a section ranging from the regulator 54b to the reagent refrigerator 21. The gas piping 71 in the section C is represented as gas piping 71C. The regulator 54b is mounted so as to reduce the gas pressure of the inert gas as compared with that in the section A and to supply the inert gas at a steady gas pressure to the reagent refrigerator 21. The gas pressure in the section C may be less than the gas pressure in the section B. A needle valve 56, a flowmeter 57 and a gas cooler 58 are arranged in the gas piping 71C from upstream to downstream. The needle valve 56 is mounted so as to adjust the flow rate of the inert gas to be supplied to the reagent refrigerator 21. The flowmeter 57 is mounted so as to monitor the flow rate of the inert gas to be supplied to the reagent refrigerator 21. The gas cooler 58 is mounted so as to cool the inert gas to be supplied to the reagent refrigerator 21. The configuration for cooling inert gas is described with reference to FIG. 3.

The inert gas supplied to the reagent refrigerator 21 is leaked through an opening of the reagent refrigerator 21. Thus, an exhaust fan 59 is mounted to an exterior cover 61 of the device, so that the inert gas leaking through the opening of the reagent refrigerator 21 is exhausted and treated by the exhaust equipment 65 connected via a connection portion 64.

FIG. 3 is a block diagram illustrating an inert gas passage and a cooling water passage in the reagent refrigerator 21. The inert gas passage is a passage illustrated in FIG. 2, which is shown here in a simplified manner. In the present embodiment, the inert gas is supplied to the reagent refrigerator 21, so that the oxygen concentrations in the reagent refrigerator 21 is lowered, to thereby inhibit occurrence of contamination within the refrigerator. For this purpose, it is effective to lower the oxygen concentrations in the vicinity of the bottom of the reagent refrigerator 21 where condensation tends to accumulate. However, in the case where nitrogen gas is used as the inert gas, a specific gravity of nitrogen gas is 0.967 (air=1), which differs little in gas density from air. Thus, in the embodiment, the nitrogen gas is cooled to increase the gas density such that the nitrogen gas is easily accumulated in the vicinity of the bottom of the reagent refrigerator 21.

For cooling the interior of the reagent refrigerator 21, a water-cooled chiller 76, and cooling water piping 75 for circulating cooling water between the water-cooled chiller 76 and the reagent refrigerator 21 are mounted. The cooling water passage is utilized for cooling the nitrogen gas. In the cooling water passage through which the cooling water is supplied from the water-cooled chiller 76 to the reagent refrigerator 21, the gas cooler 58 is connected to the cooling water piping 75 and the gas piping 71 is passed through the gas cooler 58, thereby to cool the nitrogen gas. The gas cooler 58 is placed upstream of the cooling water passage than the reagent refrigerator 21. This enables the supply of nitrogen gas at lower temperatures than the temperature of the reagent refrigerator 21. Also, it is desirable that the gas piping 71 is connected to the bottom of the reagent refrigerator 21 such that the nitrogen gas is easily accumulated in the vicinity of the bottom of the reagent refrigerator 21. The inert gas may be configured to be supplied through a plurality of points of the bottom of the reagent refrigerator 21.

The present invention is not limited to the above embodiment and also encompasses various modifications. For example, the above embodiment has been described in detail to provide a clear and understandable description of the invention, and the present invention is not necessarily limited to including all of the described configurations. Further, with respect to some configurations of the embodiments, additions, deletion and/or substitutions of other configurations can be made.

### LIST OF REFERENCE SIGNS

1 . . . mass spectroscope
10 . . . sample loader
11 . . . sample delivery portion
12, 13, 15 . . . rack transfer mechanism
14 . . . buffer
20 . . . pretreatment portion
21 . . . reagent refrigerator
22 . . . reagent replacement mechanism
22o . . . opening
23 . . . incubator
24 . . . reaction vessel feed mechanism
25 . . . reagent dispensing mechanism
26 . . . sample dispensing mechanism
27 . . . sample extraction portion
28 . . . lid
29 . . . dispensing hole
30 . . . separator
40 . . . mass spectrometry portion
50 . . . gas source
51 . . . filter
52 . . . pressure sensor
53 . . . manual valve
54 . . . regulator
55 . . . vacuum pump
56 . . . needle valve
57 . . . flowmeter
58 . . . gas cooler
59 . . . exhaust fan
60 . . . demarcation line
61 . . . exterior cover
62, 63, 64 . . . connection portion
65 . . . exhaust equipment
71 . . . gas piping
75 . . . cooling water piping
76 . . . water-cooled chiller

1. A mass spectroscope, comprising:
a reagent refrigerator for storing a reagent vessel;
a mass spectrometry portion for performing mass spectrometry on a sample which has been pretreated by reaction with a reagent contained in the reagent vessel; and
gas piping that is connected to a gas source to supply an inert gas from the gas source,
wherein the gas piping is bifurcated into a first inert gas passage for supplying the inert gas to the mass spectrometry portion and a second inert gas passage for supplying the inert gas to the reagent refrigerator.

2. The mass spectroscope according to claim 1, further comprising:
a water-cooled chiller for cooling the reagent refrigerator;
cooling water piping for circulating cooling water between the water-cooled chiller and the reagent refrigerator; and
a gas cooler that is placed on a cooling water passage for supplying the cooling water to the reagent refrigerator and cools the inert gas.

3. The mass spectroscope according to claim 2, wherein
the gas cooler uses the cooling water to cool the inert gas passing through the gas piping partly consisting of the second inert gas passage.

4. The mass spectroscope according to claim 1, wherein
the gas piping partly consisting of the second inert gas passage is connected to a bottom of the reagent refrigerator.

5. The mass spectroscope according to claim 1, wherein
the first inert gas passage is connected to a first regulator and is supplied with the inert gas reduced in pressure to below a gas pressure supplied from the gas source,
the second inter gas passage is connected to a second regulator and is supplied with the inert gas reduced in pressure to below a gas pressure supplied from the gas source, and
the gas pressure in the second inert gas passage is lower than the gas pressure in the first inert gas passage.

6. The mass spectroscope according to claim 5, wherein
a pressure sensor is placed upstream of the bifurcation of the gas piping into the first inert gas passage and the second inert gas passage to measure a gas pressure of the inert gas supplied from the gas source.

7. The mass spectroscope according to claim 5, wherein
the first inert gas passage has a first valve placed thereon to be able to interrupt supply of the inert gas to the mass spectrometry portion, and
the second inert gas passage has a second valve placed thereon to be able to interrupt supply of the inert gas to the reagent refrigerator.

8. The mass spectroscope according to claim 1, wherein
the inert gas supplied to the mass spectrometry portion is exhausted by a vacuum pump that is connected to the mass spectrometry portion,
the inert gas supplied to the reagent refrigerator is exhausted by an exhaust fan that is mounted in an exterior cover, and
the inter gas thus exhausted is treated by exhaust equipment.

9. The mass spectroscope according to claim 1, wherein
the mass spectrometry portion uses the inert gas in order to ionize the sample, and
the inert gas is nitrogen gas.
